(19) United States
(12) Patent Application Publication
(10) Pub. No.: US 2025/0168133 A1
(43) Pub. Date: May 22, 2025

(54) METHOD, APPARATUS, DEVICE AND STORAGE MEDIUM FOR CONVERSATION INTERACTION

(71) Applicant: Beijing Zitiao Network Technology Co., Ltd., Beijing (CN)

(72) Inventors: Lingyu Wang, Beijing (CN); Yingdi Sun, Beijing (CN)

(21) Appl. No.: 18/949,311

(22) Filed: Nov. 15, 2024

(30) Foreign Application Priority Data
Nov. 20, 2023 (CN) 202311553252.2

(51) Int. Cl. H04L 51/02; H04L 67/00

(52) U.S. Cl. CPC H04L 51/02; H04L 67/34

(57) ABSTRACT

According to embodiments of the disclosure, a method, an apparatus, a device, and a storage medium for conversation interaction are provided. The method includes: receiving a configuration operation from a first user, the configuration operation being configured to configure a first digital assistant to replace the first user to interact with a second user; and in response to the configuration operation taking effect, displaying an interaction portal of the first digital assistant in an interface associated with the first user, so that the second user interact with the first digital assistant. In this manner, the digital assistant can help the user to interact with other users. Further, by replacing the user to interact with other users, the efficiency of the digital assistant in assisting the user can be improved.

### CROSS-REFERENCE

The present application claims priority to Chinese Patent Application No. 202311553252.2, filed on Nov. 20, 2023 and entitled “METHOD, APPARATUS, DEVICE AND STORAGE MEDIUM FOR CONVERSATION INTERACTION”, the entirety of which is incorporated herein by reference.

### FIELD

Example embodiments of the present disclosure generally relate to the field of computers, and more particularly, to a method, an apparatus, a device, and computer-readable storage medium for conversation interaction.

### BACKGROUND

With the development of information technologies, various terminal devices can provide various services for people in the aspects of work, life, and the like. An application providing a service may be deployed in a terminal device, and the terminal device or the application may provide a digital assistant type function for a user, so as to assist the user in using the terminal device or the application. How to improve the flexibility of interaction between a user and a digital assistant is a technical problem to be explored at present.

### SUMMARY

In a first aspect of the present disclosure, a method for conversation interaction is provided. The method includes: receiving a configuration operation from a first user, the configuration operation being configured to configure a first digital assistant to replace the first user to interact with a second user; and in response to the configuration operation taking effect, displaying an interaction portal of the first digital assistant in an interface associated with the first user, so that the second user interact with the first digital assistant.

In a first aspect of the present disclosure, a method for conversation interaction is provided. The method includes: displaying an interaction portal of a first digital assistant in an interface associated with a first user; in response to receiving a triggering operation for the interaction portal from a second user, displaying a conversation interface between the second user and the first digital assistant; and executing interaction between the first digital assistant and the second user in the conversation interface.

In a third aspect of the present disclosure, an apparatus for conversation interaction is provided. The apparatus includes: a configuration operation receiving module configured to receive a configuration operation from a first user, the configuration operation being configured to configure a first digital assistant to replace the first user to interact with a second user; and an interaction portal displaying module configured to display, in response to the configuration operation taking effect, an interaction portal of the first digital assistant in an interface associated with the first user, so that the second user interact with the first digital assistant.

In a fourth aspect of the present disclosure, an apparatus for conversation interaction is provided. The apparatus includes: an interaction portal displaying module configured to display an interaction portal of a first digital assistant in an interface associated with a first user; a conversation interface displaying module configured to display, in response to receiving a triggering operation for the interaction portal from a second user, a conversation interface between the second user and the first digital assistant; and an execution module configured to execute interaction between the first digital assistant and the second user in the conversation interface.

In a fifth aspect of the present disclosure, an electronic device is provided, the device including at least one processing unit; and at least one memory, the at least one memory being coupled to the at least one processing unit and storing instructions for execution by the at least one processing unit, the instructions, when executed by the at least one processing unit, cause the electronic device to perform the method of the first aspect and/or the second aspect.

In a sixth aspect of the present disclosure, a computer readable storage medium is provided, on which a computer program is stored, the computer program being executable by a processor to implement the method in the first aspect and/or the second aspect.

It should be appreciated that what is described in this Summary is not intended to limit critical features or essential features of embodiments of the disclosure, nor is it intended to limit the scope of the disclosure. Other features of the present disclosure will become readily appreciated from the following description.

### BRIEF DESCRIPTION OF THE DRAWINGS

The above and other features, advantages, and aspects of various embodiments of the present disclosure will become more apparent with reference to the following detailed description taken in conjunction with the accompanying drawings. In the drawings, the same or similar reference numerals denote the same or similar elements, wherein:

FIG. 1 illustrates a schematic diagram of an example environment in which embodiments of the present disclosure can be implemented;

FIGS. 2A-2D illustrate schematic diagrams of example interfaces for configuration operations according to some embodiments of the disclosure.

FIGS. 3A-3D illustrate schematic diagrams of example interfaces for configuration operations according to further embodiments of the present disclosure;

FIGS. 4A-4D illustrate schematic diagrams of example interfaces for effective indication according to some embodiments of the present disclosure;

FIGS. 5A-5D illustrate schematic diagrams of example interfaces involving a deactivation control according to some embodiments of the present disclosure;

FIGS. 6A-6C illustrate schematic diagrams of example interfaces involving the deactivation control according to further embodiments of the present disclosure;

FIGS. 7A-7C illustrate schematic diagrams of example interfaces including an interaction portal according to some embodiments of the disclosure;

FIG. 8 illustrates a flowchart of an example process for conversation interaction according to some embodiments of the disclosure;

FIG. 9 illustrates a flowchart of an example process for conversation interaction according to some embodiments of the disclosure;

FIG. 10 illustrates a schematic structural block diagram of an apparatus for conversation interaction according to some embodiments of the disclosure;

FIG. 11 illustrates a schematic structural block diagram of an apparatus for conversation interaction according to further embodiments of the present disclosure; and

FIG. 12 illustrates a block diagram of an electronic device capable of implementing one or more embodiments of the present disclosure.

### DETAILED DESCRIPTION

It should be understood that, before the technical solutions disclosed in the embodiments of the present disclosure are used, the user should be informed of the type of the personal information, the usage range, the usage scenario, and the like related to the present disclosure in an appropriate manner and the authorization of the user should be obtained according to relevant legal regulations.

For example, in response to receiving an active request from a user, prompt information is sent to the user to explicitly prompt the user that an operation requested by the user will require acquisition and use of personal information of the user. Thus, the user can autonomously select, according to the prompt information, whether to provide personal information to software or hardware such as an electronic device, an application program, a server, or a storage medium that executes the operations of the technical solutions of the present disclosure.

As an optional but non-limiting implementation, in response to receiving an active request of a user, a manner of sending prompt information to the user may be, for example, a manner of a pop-up window, where the pop-up window may present the prompt information in a text manner. In addition, the popup window may also carry a selection control for the user to select ‘agree’ or ‘don't agree’ to provide personal information to the electronic device.

It can be understood that, the above notification and acquisition of the user authorization process are merely exemplary, and do not limit the implementation of the present disclosure, and other methods meeting relevant legal regulations may also be applied to the implementation of the present disclosure.

It is to be understood that the data involved in the technical solution (including but not limited to the data itself, the acquisition or use of the data) should comply with the requirements of the corresponding legal regulations and related provisions.

Embodiments of the present disclosure will be described in more detail below with reference to the accompanying drawings. Although certain embodiments of the present disclosure are shown in the accompanying drawings, it should be understood that the present disclosure may be implemented in various forms and should not be construed as limited to the embodiments set forth herein, but rather, these embodiments are provided for a thorough and complete understanding of the present disclosure. It should be understood that the drawings and embodiments of the present disclosure are only for illustrative purposes and are not intended to limit the scope of the present disclosure.

It should be noted that the headings of any section/subsection provided herein are not limiting. Various embodiments are described throughout herein, and any type of embodiment can be included under any section/subsection. Furthermore, embodiments described in any section/subsection may be combined in any manner with any other embodiments described in the same section/subsection and/or different sections/subsections.

Herein, unless explicitly stated otherwise, “performing a step in response to A” does not mean that the step is performed immediately after “A”, but may include one or more intermediate steps.

In the description of the embodiments of the present disclosure, the term “including” and the like should be understood as open-ended including, that is, “including but not limited to”. The term “based on” should be read as “based at least in part on.” The term “one embodiment” or “the embodiment” should be read as “at least one embodiment”. The term “some embodiments” should be understood as “at least some embodiments.” Other explicit and implicit definitions may also be included below. The terms “first”, “second”, etc. may refer to different or identical objects. Other explicit and implicit definitions may also be included below.

As used herein, the term “model” may learn associations between corresponding inputs and outputs from training data, such that after training, corresponding output may be generated for given input. The generation of the model may be based on a machine learning technique. Deep learning is a machine learning algorithm that processes inputs and provides corresponding outputs by using a multi-tiered processing unit. A “model” may also be referred to herein as a “machine learning model,” a “machine learning network,” or a “network”, and these terms may be used interchangeably herein. A model may in turn include various types of processing units or networks.

### Example Environment

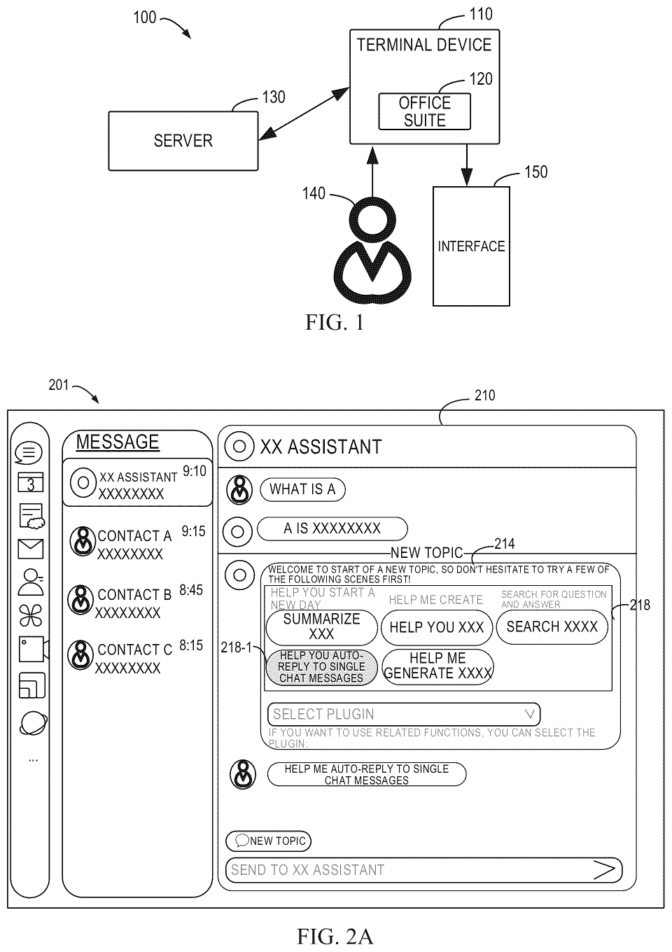

FIG. 1 illustrates a schematic diagram of an example environment 100 in which embodiments of the present disclosure can be implemented. In this example environment 100, an office suite 120 is installed in a terminal device 110. The user 140 may interact with office suite 120 via terminal device 110 and/or an attached device of terminal device 110. The office suite 120 can provide a user 140 with an integration of multiple applications or components. These applications can serve as application modules in office suite 120. These applications integrated in office suite 120 are sometimes also referred to as “office applications”, “office components”, “collaborative office platforms”, etc. As an example, the applications integrated in the office suite 120 may include, but are not limited to, one or more of a chat application (also referred to as an instant messaging (IM) application), a document application, an audio-video conferencing application, a mail application, a calendar application, a scheduling application, a task application, a objectives and key result (OKR) application.

In some embodiments, the office suite 120 may be downloaded and installed on the terminal device 110 as an application. In some embodiments, the office suite 120 may also be accessed in other ways, such as through a web page, etc.

In the environment 100 of FIG. 1, if the office suite 120 is launched, the terminal device 110 may present an interface 150 of the office suite 120 to the user 140. The interface 150 is sometimes referred to as a client interface. The interface 150 may include a variety of interfaces that may be provided by the office suite 120, such as a conversation interface that presents chat content, a video conferencing interface, a file sharing interface, and so forth.

In some embodiments, the terminal device 110 communicates with server 130 to enable provision of services of office suite 120. The terminal device 110 may be any type of mobile terminal, fixed terminal, or portable terminal including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a television receiver, a radio broadcast receiver, an electronic book device, a game device, or any combination of the foregoing, including accessories and peripherals for these devices, or any combination thereof. In some embodiments, the terminal device 110 can also support any type of interface to a user (such as “wearable” circuitry, etc.). The server 130 may be various types of computing systems/servers capable of providing computing capabilities including, but not limited to, mainframe computers, edge computing nodes, computing devices in a cloud environment, etc.

It shall be understood that the structure and function of the various elements in environment 100 are described for exemplary purposes only, and are not intended to imply any limitation on the scope of the disclosure. For example, the embodiments of the present disclosure may be applied to any suitable application(s) and is not limited to office suites.

As mentioned briefly above, a digital assistant may be provided to a user to assist the user in completing a target task using a terminal device or an application. In the embodiments of the present disclosure, a digital assistant is configured for user 140. The digital assistant may be implemented in any suitable form. In some embodiments, the digital assistant of user 140 may interact with the user as a contact of user 140. Such a digital assistant may also uniquely correspond to the user 140. In other words, the digital assistant of the user 140 may be specific or particularly belong to the user 140. If the user 140 is an individual or a person, such a digital assistant may be regarded as a personal digital assistant. It can be understood that, in the embodiment of the present disclosure, the digital assistant is based on data to which the user 140 is authorized to access the authorized data.

It should be understood that “uniquely correspond to” or similar expression in the present disclosure is not intended to limit that a digital assistant will be updated accordingly based on an interaction process between the user 140 and the digital assistant.

In an embodiment of the present disclosure, a digital assistant is used for interaction with a user. An interactive window for the user to interact with the digital assistant may be presented in a client interface. As an intelligent assistant, a digital assistant has an intelligent conversation and information processing capability. In an interactive window, a user inputs an interaction message, and the digital assistant provides a reply message in response to the user input. A client interface for providing a digital assistant may correspond to a single-function application or a multi-function collaboration platform, such as an office suite or other collaboration platform capable of integrating multiple components.

The interactive window between the user and the digital assistant may include a conversation window in which the interaction between the user and the digital assistant may be presented in the form of a conversation message. Alternatively, or additionally, the interactive window between the user and the digital assistant may also include a non-interactive window, for example, a window in a floating window mode, in which the user may trigger the digital assistant to perform a corresponding operation by inputting an instruction, selecting a shortcut instruction, or the like.

In some embodiments, after evoking the digital assistant through a preset application, the user 140 interacts with the digital assistant through a main conversation. The interactive window corresponding to the main conversation may be referred to as a primary conversation window. As an example, the preset application may be an IM application in an office suite. In other examples, the predefined application may also be other applications or components.

In some embodiments, the digital assistant may also be evoked and interacted with by other applications than the preset application. After the digital assistant is evoked through these non-preset applications, the user may interact with the digital assistant through a sub-conversation. An interactive window corresponding to a sub-conversation may be referred to as a sub-conversation window. For example, a user may evoke a digital assistant through a page in a document application, thereby interacting with the digital assistant through the sub-conversation.

As briefly described above, a terminal device or an application may provide a digital assistant-like function to a user to assist the user in using the terminal device or the application. However, flexibility of interaction between a user and a digital assistant is a technical problem to be explored at present.

According to various embodiments of the present disclosure, a first user may provide a configuration operation for configuring a first digital assistant to replace a first user to interact with a second user. In a case that the configuration operation takes effect, the interaction portal of the first digital assistant is shown in the interface associated with the first user, so that the second user can interact with the first digital assistant. Thus, in this manner, the digital assistant can be enabled to assist the user in interacting with other users, for example, to automatically reply to other users' questions with respect to the scope authorized by the user. In this way, the digital assistant can help the user to answer some questions, such as when the user is not available to reply. Thus, the assisting efficiency of the digital assistant for the user can be advantageously improved.

Some example embodiments of the present disclosure will be described below with continued reference to the drawings. It should be understood that the pages shown in the drawings are only examples, and that a variety of page designs may exist in practice. Various graphical elements in a page may have different arrangements and different visual representations, one or more of which may be omitted or replaced, and one or more other elements may also be present. Embodiments of the present disclosure are not limited in this regard.

In some embodiments, to enable the digital assistant to replace the first user in interacting with other users (also referred to as second users), the terminal device 110 first receives a configuration operation from the first user. This configuration operation is used to configure the first digital assistant to replace the first user in interacting with the second user. Herein, the digital assistant replacing the user in interacting with other users is also referred to as an automatic response task.

In some embodiments, the configuration operation may include selecting a data source required when the first digital assistant is interacting with the second user. For example, the data source may be a document, a file, or a topic, etc. Alternatively, or additionally, in some embodiments, the configuration operation may also be setting to the second user a guide phrase set by the first user. The guide phrase is used to inform the second user that the first digital assistant can help the first user reply, so that the second user interacts with the first digital assistant. The configuration operation may also include other suitable operations, for example, setting time information about when the first digital assistant replaces the first user to interact with the second user (for example, periodically), setting a range of the second user (namely, which users the first digital assistant can interact with instead of the first user), and the like.

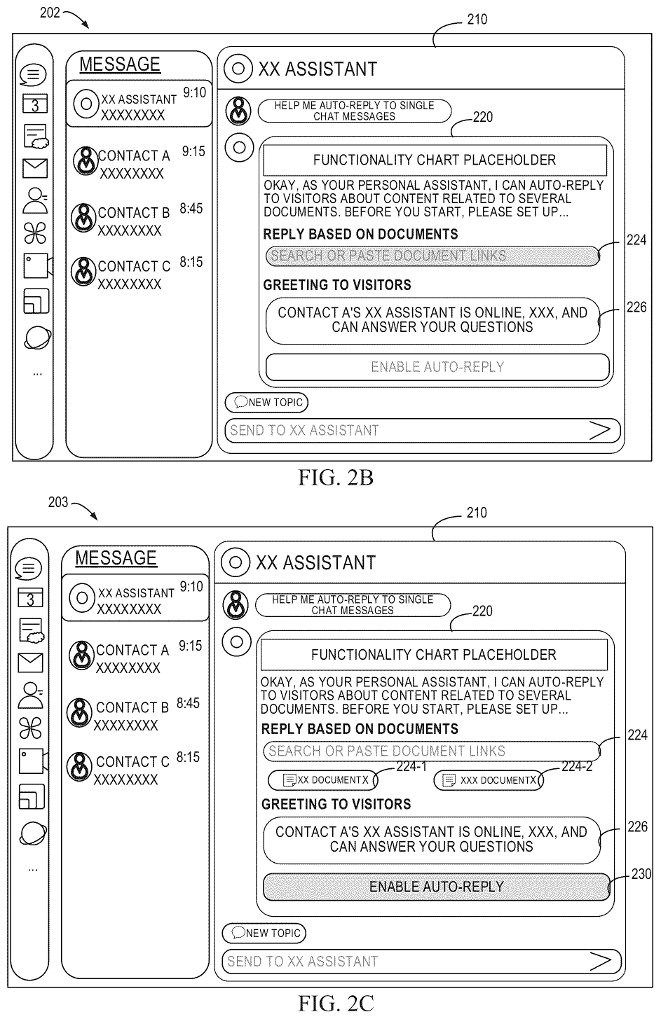

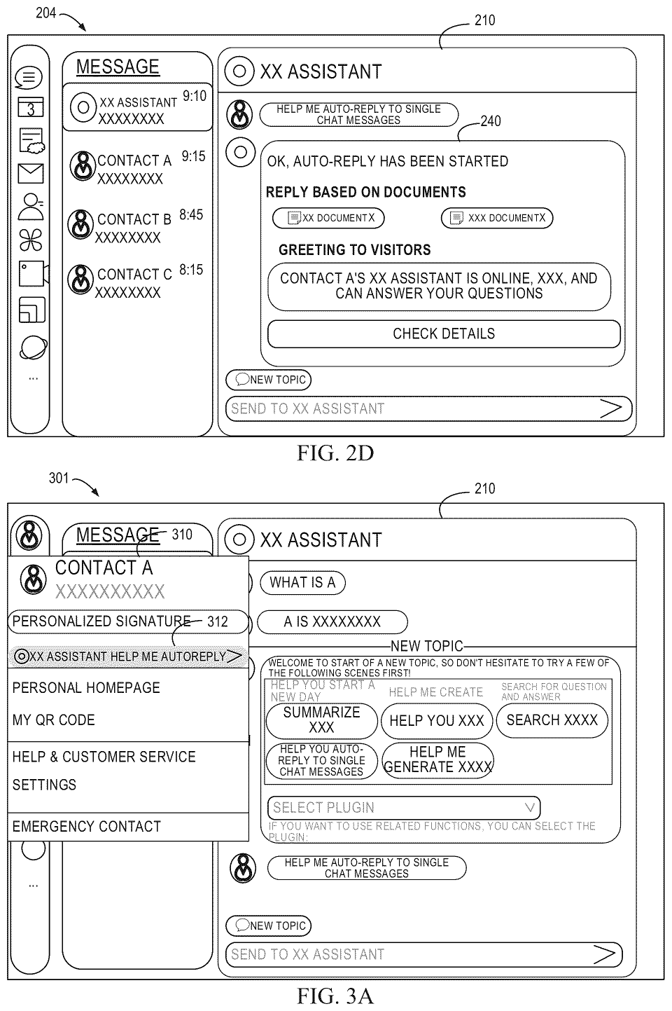

In some embodiments, the terminal device 110 may receive the configuration operation from the first user through a conversation interface between the first user and the first digital assistant. Such a conversation interface may be used, for example, for a main conversation or sub-conversation between the first user and the first digital assistant. Examples of the terminal device 110 receiving the configuration operation from user 140 are described below with reference to FIGS. 2A-2D. FIGS. 2A-2D illustrate schematic diagrams of example interfaces for configuration operations according to some embodiments of the disclosure. As shown in the diagram 201 of FIG. 2A, the terminal device 110 may receive a configuration operation from a first user via the conversation interface 210.

The terminal device 110 presents a first message from the first digital assistant in the conversation interface 210, such as the first message 220 in the schematic diagram shown in FIG. 2B. The terminal device 110 provides a configuration control 224 in the first message 220, the configuration control 224, for example, supports the first user to configure which data source(s) (e. g. document(s)) the first digital assistant can reply to. The first user clicks the configuration control 224, and the terminal device 110 may receive the configuration operation of the first user through the configuration control 224.

In the diagram 202 shown in FIG. 2B, the terminal device 110 also supports a first user to configure a guide phrase 226 for a visitor (i. e., a second user) on the configuration page. When the second user clicks on the conversation portal, the terminal device 110 presents a guide phrase sent from the first assistant to the second user, e. g., “the digital assistant of contact A is online to answer your questions”.

In one example, the first user can conduct a search or paste a document link by clicking on the configuration control 224. The terminal device 110 may receive the document searched or pasted by the first user through the configuration control 224. As shown in a schematic diagram 203 in FIG. 2C, the terminal device 110 receives a document searched or pasted by the first user through the configuration control 224, and displays the document in the conversation window 210, for example, an element 224-1 indicating “XX document” and an element 224-2 indicating “XXX document”.

The terminal device 110 receives, through the configuration control 224, the document searched or pasted by the first user, and after the document is shown in the conversation window 210, the terminal device 110 receives a click from the first user to start an automatic reply. As shown in FIG. 2C, after the first user completes the configuration operation on the configuration page, the first user clicks the “Start Auto Reply” control 230. That is, the terminal device 110 receives confirmation on the configuration operation, such that the configuration operation takes effect. Accordingly, the terminal device 110 may show a reply message from the first digital assistant. As shown in the schematic diagram 204 in FIG. 2D, the terminal device 110 shows the reply message 240 from the first digital assistant.

In some embodiments, displaying of the first message described above may be triggered by a preset shortcut instruction. Specifically, the terminal device 110 may show, in the conversation window 210, a second message from the first digital assistant, such as the second message 214 in the diagram 201 shown in FIG. 2A. One or more preset shortcut instructions 218 may be included in the second message 214. The preset shortcut instructions 218 may include functions such as: a function like the first digital assistant helping the first user start a new day, a function like the first digital assistant helping the first user create, a function like the first digital assistant helping the first user search for a question and answer, etc. For example, the function like the first digital assistant helping the first user to start a new day may be summarizing a collusion document, the first digital assistant helping the first user automatically reply to single-chat information, and so on. The function like the first digital assistant helping the first user create may be as follows: the first digital assistant helps the first user generate XX, etc. The function like the first digital assistant helping the first user search for the question and answer may be as follows: the first digital assistant helps the first user search for XXX, etc. When the first user clicks the preset shortcut instruction 218-1, the terminal device 110 shows the first message 220.

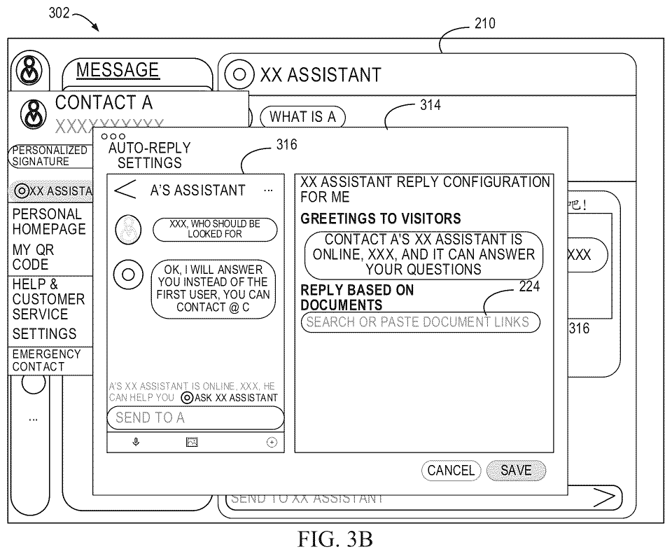

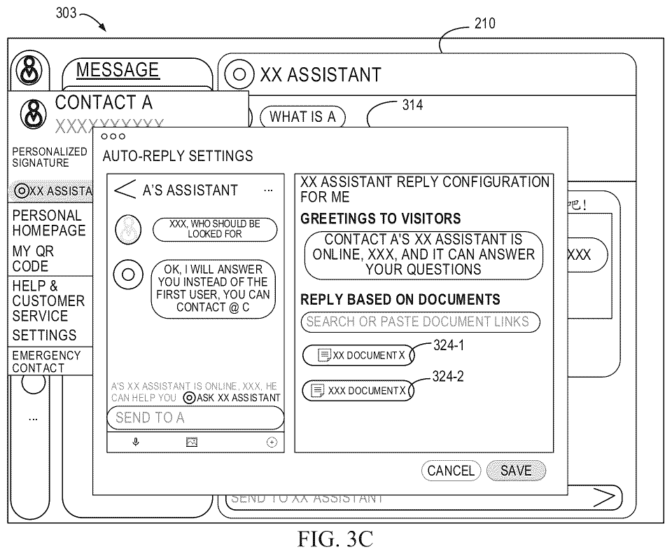

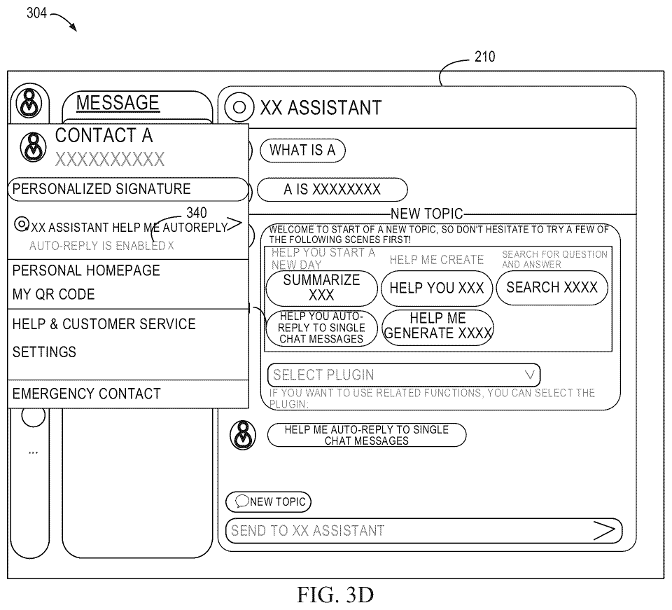

An example of receiving a configuration operation through a conversation interface between the first user and the first digital assistant was described above. Alternatively, or additionally, in some examples, the terminal device 110 may receive the configuration operation from the first user via the user personal homepage of the first user. The following describes the terminal device 110 receiving the configuration operation from the first user via the user personal homepage 140 of the first user with reference to FIG. 3A to FIG. 3D. FIGS. 3A-3D illustrate schematic diagrams of example interfaces for a configuration operation according to some embodiments of the disclosure. Hereinafter, FIGS. 3A through 3D are described from a perspective of a terminal device 110 for ease of discussion, but it is only exemplary.

In some embodiments, the terminal device 110 may also receive the configuration operation from the first user through a user personal homepage of the first user. As shown in a schematic diagram 301 in FIG. 3A, the terminal device 110 receives the configuration operation from the first user through a personal homepage 310 of the first user (named “contact A”).

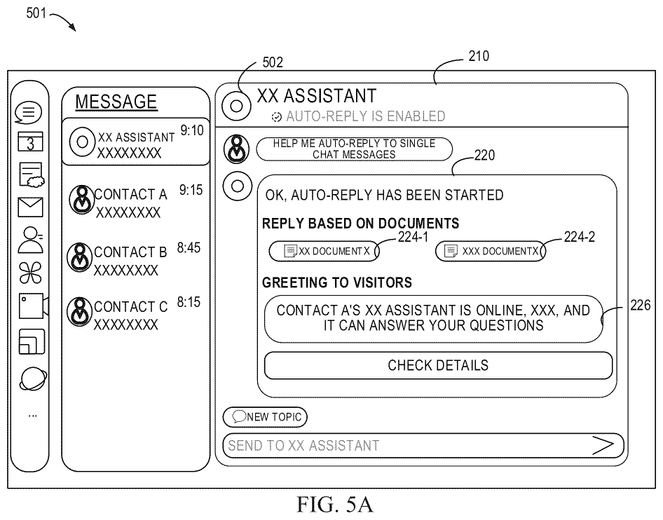

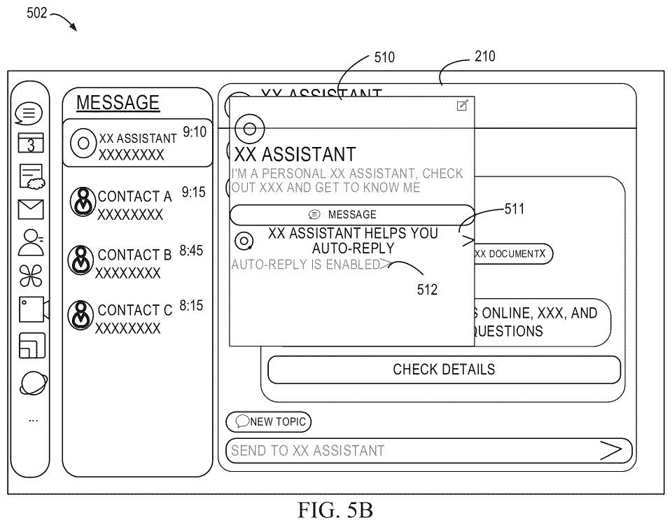

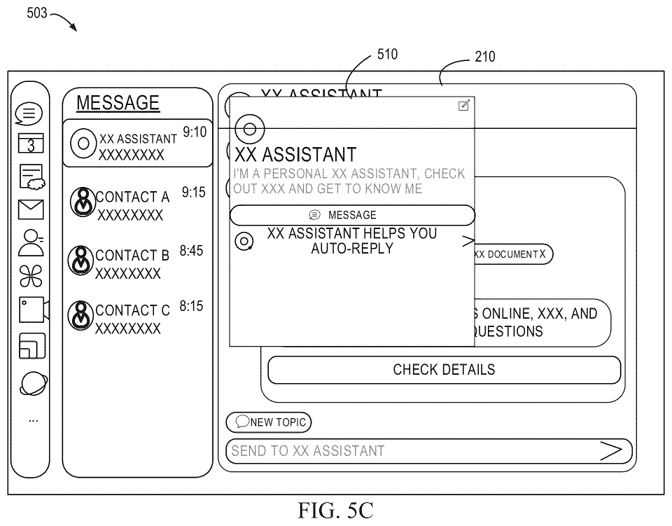

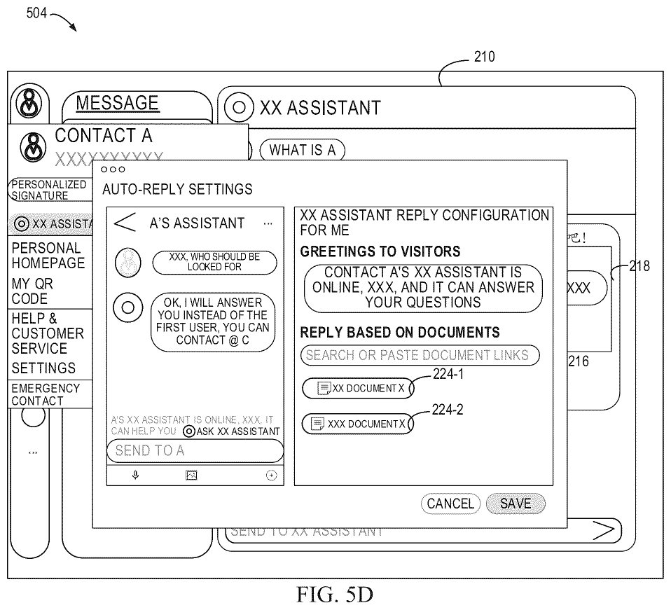

Alternatively, or additionally, in some embodiments, the terminal device 110 may receive the configuration operation from the first user via a personal homepage of a digital assistant. As will be described below, the terminal device 110 receives a configuration operation from a first user through a personal homepage 510 of a first digital assistant, as illustrated in a schematic diagram 502 in FIG. 5B. An exemplary embodiment of a personal homepage 510 of a first digital assistant will be described below with reference to FIG. 5B. In an embodiment of the present disclosure, the digital assistant may act as a certain user in an office suite 120; therefore, the personal homepage of the digital assistant is similar to the personal homepage of the user, and the present disclosure does not limit thereto.

Continuing with the description of FIG. 3A to FIG. 3D, the terminal device 110 shows a configuration portal on the personal homepage 310 of the user or the personal homepage of the digital assistant. The configuration portal is a portal for configuring the first digital assistant to replace the first user to interact with the second user. As illustrated in diagram 301 of FIG. 3A, the terminal device 110 shows a configuration portal 312 in the personal homepage 310 of the first user.

The configuration portal 312 may be triggered by a user, that is, when the first user clicks on the configuration portal 312, the terminal device 110 shows a configuration interface. The configuration interface is an interface used by the first user to configure the first digital assistant to replace the first user to interact with the second user. Referring to diagram 302 shown in FIG. 3B, a first user clicks on the configuration portal 312 and the terminal device 110 shows a configuration interface 314.

The configuration interface 314 may include an example of a first digital assistant in place of a first user in interacting with a second user, as shown in an example 316 in FIG. 3B. For example, in the example 316, the first user receives a message from the second user “I want to know XX, who should be looked for” and the first digital assistant replies a message, “OK, I will answer you instead of the first user, you can contact user C’. With such example, the first user may be assisted in better understanding that the first digital assistant may replace the first user for interaction.

The configuration interface 314 may also include a configuration control 224. The first user may search or paste a document link by clicking the configuration control 224. The terminal device 110 may receive, through the configuration control 224, a document searched or pasted by the first user, and the terminal device 110 may receive, through the configuration control 224, the document searched or pasted by the first user as a data source. As shown in a schematic diagram 303 in FIG. 3C, the terminal device 110 receives the document searched or pasted by the first user through the configuration control 224, and shows the document in the configuration interface 314, for example, an element 324-1 for “XX document” and an element 324-2 for “XX document”.

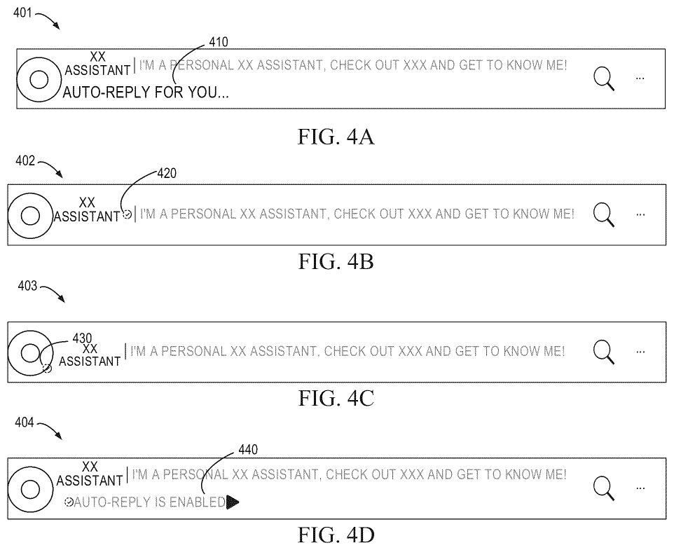

In some instances, in a case where the configuration operation takes effect, the terminal device 110 shows an indication indicating that the configuration operation takes effect. The terminal device 110 displaying the indication indicating that the configuration operation takes effect is described below with respect to FIGS. 4A-4D. FIGS. 4A-4D illustrate schematic diagrams of example interfaces for an indication of taking effect according to some embodiments of the disclosure. Hereinafter, FIGS. 4A to 4D are described in terms from the perspective of the terminal device 110 for ease of discussion, but this is only exemplary.

In some embodiments, in a case where the configuration operation takes effect, the terminal device 110 may show, in a conversation interface between the first user and the first digital assistant, text describing that the first digital assistant replaces the first user to interact with the second user. As shown in diagram 401 in FIG. 4A, the terminal device 110 shows description text 410 “Help you auto-reply . . . ”. As shown in the diagram in FIG. 4D, the terminal device 110 shows description text 440 “Auto-reply has been started”. As shown in the schematic diagram 304 in FIG. 3D, the terminal device 110 shows description text 340 “Terminal reply is started” on the personal homepage 310 of the first user.

In some examples, in a case where the configuration operation takes effect, the terminal device 110 may show an icon in a conversation interface between the first user and the first digital assistant, where such icon represents that the first digital assistant performs interaction with the second user in place of the first user. Referring to diagram 402 shown in FIG. 4B, the terminal device 110 shows an “icon” 420. Referring to diagram 403 shown in FIG. 4C, the terminal device 110 shows an “icon” 430.

In some examples, in a case where the configuration operation takes effect, the terminal device 110 may show an icon and description text in a conversation interface between the first user and the first digital assistant. As shown in the diagram 404 in FIG. 4D, the terminal device 110 presents an “icon” plus description text 440 “Auto-reply has been started”.

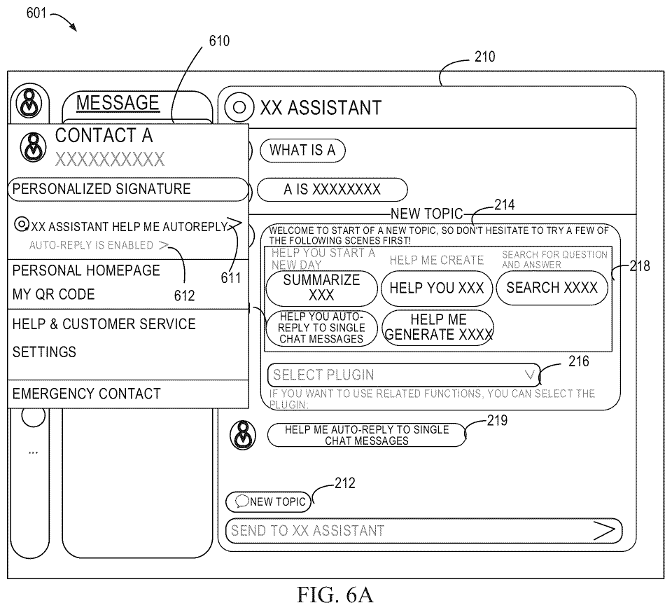

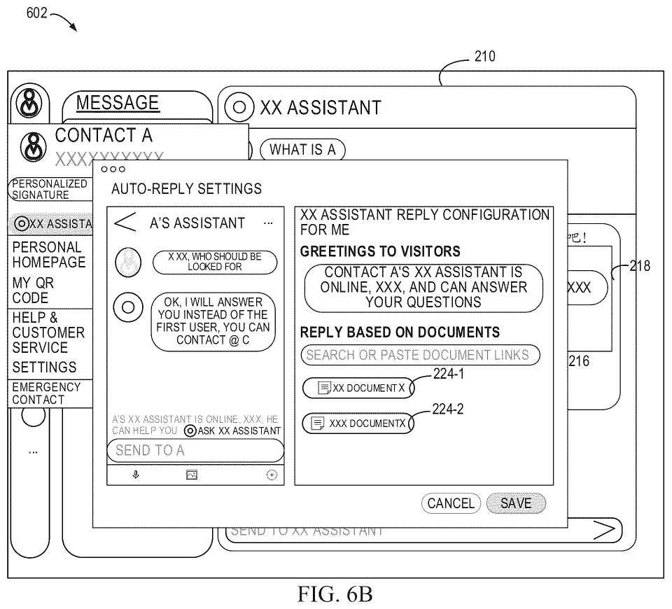

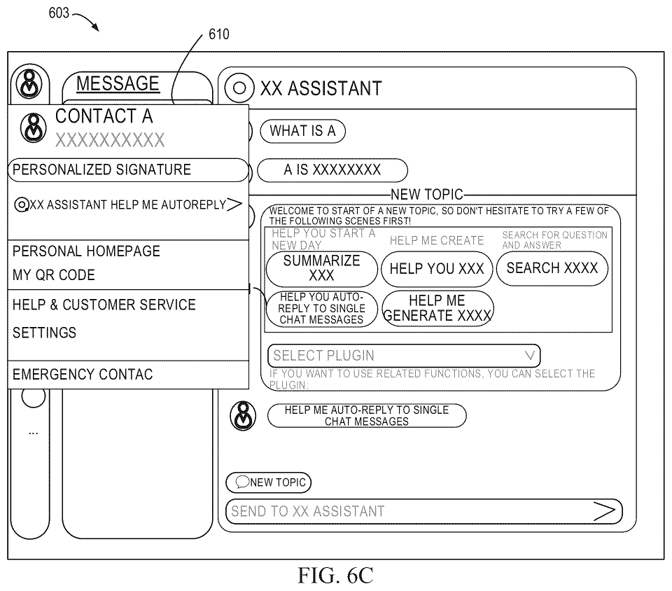

In some examples, in a case where the configuration operation takes effect, the terminal device 110 shows the deactivation control. The terminal device 110 displaying the deactivation control is described below with reference to FIGS. 5A-6C. FIGS. 5A-6C illustrate schematic diagrams of example interfaces in accordance with some embodiments of the disclosure. In the following, for ease of discussion, FIGS. 5A-6C are described from the perspective of the terminal device 110, but this is merely exemplary.

In some embodiments, in a case where the configuration operation takes effect, the terminal device 110 shows the deactivation control in a user personal homepage of the first user or in an assistant personal homepage of the first digital assistant. When the first user clicks on the deactivation control, the terminal device 110 disables the function of first digital assistant interacting with the second user in place of the first user.

As shown in a schematic diagram 501 shown in FIG. 5A, in a case where a configuration operation comes into effect, if a user clicks on an icon 502 of a digital assistant, the terminal device 110 may show an assistant personal homepage 510 of a first digital assistant, as shown in FIG. 5B. In the assistant personal homepage 510, there is provided a portal 511 for the configuration page and a deactivation control 512. If the user triggers the portal 511, the terminal device 110 may show the configuration page, as shown in FIG. 5D. If the user triggers the deactivation control 512, the terminal device 110 may stop the active reply task of the first digital assistant. Meanwhile, the terminal device 110 may stop displaying the text “Auto-reply has been started” in the personal homepage of the digital assistant, such as shown in FIG. 5C.

As shown in a schematic diagram 601 in FIG. 6A, in a case where a configuration operation comes into effect, the terminal device 110 shows the text “Auto-reply has been started”, a portal 611 for the configuration page, and a deactivation control 612 in the user personal homepage 610 of the first user. If the user triggers the portal 611, the terminal device 110 may show a configuration page, such as shown in FIG. 6B. If the user triggers the deactivation control 612, the terminal device 110 may stop the active reply task of the first digital assistant. Meanwhile, the terminal device 110 may stop displaying the text “Auto reply has been started” in the user personal homepage 610 of the first user, such as shown in FIG. 6C.

In some embodiments, in a case where a configuration operation comes into effect, the terminal device 110 shows an interaction portal of the first digital assistant in an interface associated with the first user. The interaction portal is configured for the first digital assistant to replace the first user to interact with the second user. The interface associated with the first user includes, but is not limited to, an interface 710 for conversation interaction between the first user and the second user, a user personal homepage 310 of the first user.

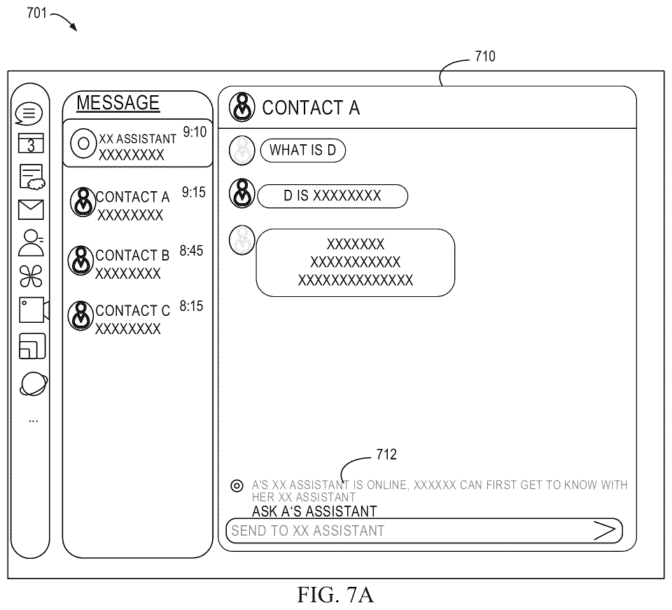

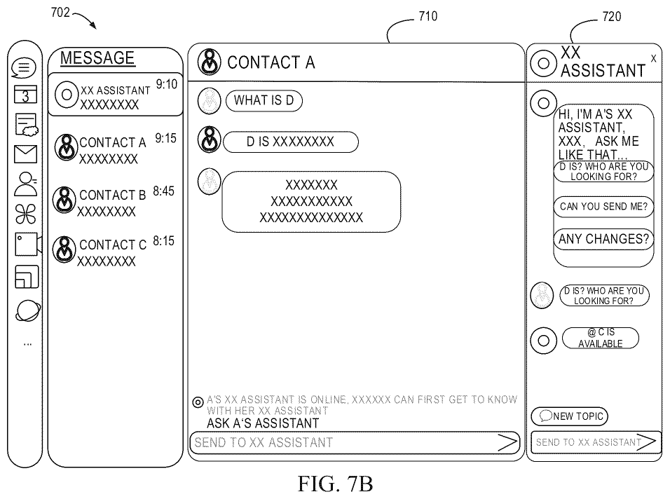

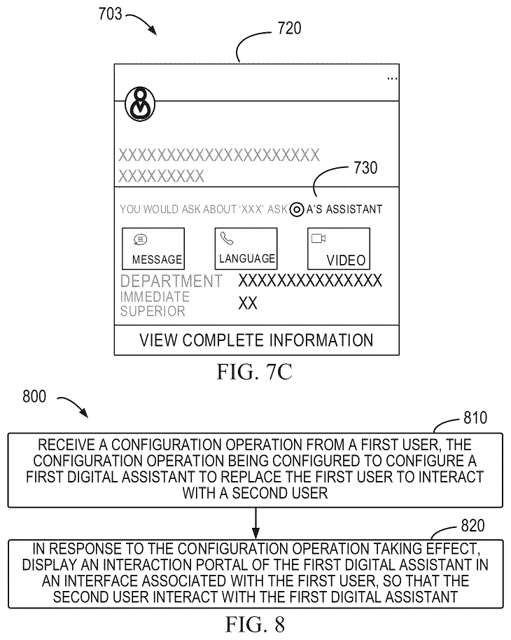

An example is described below with reference to FIGS. 7A-7C. FIGS. 7A-7C illustrate schematic diagrams of example interfaces including an interaction portal, according to some embodiments of the disclosure. Hereinafter, FIGS. 7A-7C are described from the perspective of the terminal device 110 for ease of discussion, but this is merely exemplary.

As shown in the schematic diagram 701 of FIG. 7A, the terminal device 110 shows, in a conversation interface 710 between a first user and a second user, an interaction portal 712 for a first digital assistant to replace the first user to interact with the second user. For example, when the second user is to interact with the first user, in an interface 710 where the first user interacts with the second user, the second user may click on the interaction portal 712.

As shown in a schematic diagram 703 in FIG. 7C, the terminal device 110 shows, in a user personal homepage 720 of the first user, an interaction portal 730 for the first digital assistant to replace the first user to interact with the second user. For example, when the second user interacts with the first user, in the user personal homepage 310 of the first user, the second user may click on the interaction portal 730.

In some embodiments, when the second user clicks on the interaction portal, the terminal device 110 shows a conversation interface for the first digital assistant to replace the first user to interact with the second user. As shown in a schematic diagram 702 in FIG. 7B, the terminal device 110 shows a conversation interface 720 for the first digital assistant to replace the first user to interact with the second user.

The terminal device 110 shows the conversation interface 720, and performs interaction between the first digital assistant and the second user in the conversation interface 720. For example, the terminal device 110 receives a second user's message “Who can I talk to about document XX?”, and the terminal device 110 shows a reply “User C is available” to the first digital assistant.

In some embodiments, the terminal device 110 may show, to the first user, interaction information with the second user when the first digital assistant replaces the first user. In this way, the first user may be aware of the interaction content between the first digital assistant and the second user.

As one example, the terminal device 110 may show a message from a first digital assistant in a conversation interface between the first user and the first digital assistant. Interaction information between the first digital assistant and the second user is presented in the message. For example, the first digital assistant may merge interaction information between the second user and the first digital assistant and forward the information to the main conversation between the first user and the first digital assistant.

As another example, the terminal device 110 may show, in a conversation interface between the first user and the first digital assistant, a plurality of messages generated in an interaction process between the first digital assistant and the second user in an aggregation manner. For example, the terminal device 110 may present a message card in a main conversation between the first user and the first digital assistant, where the message card shows a plurality of interaction messages in an aggregation manner.

As another example, the terminal device 110 may show, in a conversation interface between the first user and the second user, a plurality of messages generated in an interaction process between the first digital assistant and the second user. For example, a plurality of messages interacted between the second user and the first digital assistant may be shown in a conversation window between the first user and the second user.

In the above description, a single chat conversation between a first user and a second user is taken as an example, but it should be understood that a conversation interface between the first user and the second user may also be used for a group chat conversation including the first user and the second user. Additionally, various processes and operations are illustrated above as being implemented at the terminal device 110. It should be appreciated that some of the operations described with reference to the terminal device 110 may require the assistance of the server 130. It should be noted that the operation executed by the terminal device 110 may be specifically executed by a related application and/or a digital assistant installed on the terminal device 110.

### Example Processes

FIG. 8 illustrates a flowchart of a process 800 for conversation interaction according to some embodiments of the disclosure. The process 800 may be implemented at a digital assistant on a terminal device 110 and/or a terminal device 110. The process 800 is described below with reference to FIG. 1.

At block 810, the terminal device 110 receives a configuration operation from a first user, the configuration operation being configured to configure a first digital assistant to replace the first user to interact with a second user.

At block 820, in response to the configuration operation taking effect, the terminal device 110 displays an interaction portal of the first digital assistant in an interface associated with the first user, so that the second user interact with the first digital assistant.

In some embodiments, receiving the configuration operation from the first user includes receiving the configuration operation via at least one of: a conversation interface between the first user and the first digital assistant, a user personal homepage of the first user, or an assistant personal homepage of the first digital assistant.

In some embodiments, receiving the configuration operation via the conversation interface includes: displaying a first message from the first digital assistant in the conversation interface, the first message being provided with a configuration control; and receiving the configuration operation via the configuration control.

In some embodiments, displaying the first message from the first digital assistant includes: displaying a second message from the first digital assistant in the conversation interface, the second message being provided with a preset shortcut instruction; and in response to the preset shortcut instruction being triggered, displaying the first message.

In some embodiments, receiving the configuration operation via the user personal homepage or the assistant personal homepage includes: displaying, in the user personal homepage or the assistant personal homepage, a configuration portal for configuring the first digital assistant to replace the first user to interact with the second user; in response to the configuration portal being triggered, displaying a configuration interface for configuring the first digital assistant to replace the first user to interact with the second user; and receiving the configuration operation in the configuration interface.

In some embodiments, an example in which the first user is replaced by the first digital assistant for interaction is further presented in the configuration interface.

In some embodiments, displaying the interaction portal of the first digital assistant in the interface associated with the first user includes displaying the interaction portal in at least one of: a conversation interface between the second user and the first user, or a personal homepage of the first user.

In some embodiments, the process 800 further includes displaying, to the first user, information relating to interaction between the first digital assistant and the second user.

In some embodiments, displaying the information relating to the interaction between the first digital assistant and the second user includes at least one of: displaying, in a conversation interface between the first user and the first digital assistant, a message from the first digital assistant, the message including a record of the interaction; displaying, in a conversation interface between the first user and the first digital assistant, a plurality of messages generated in the interaction in an aggregate form; or displaying, in a conversation interface between the first user and the second user, the plurality of messages generated in the interaction.

In some embodiments, the process 800 further includes: in response to the configuration operation taking effect, displaying, in a conversation interface between the first user and the first digital assistant, at least one of the following: text describing interaction of the first digital assistant in place of the first user, or an icon representing interaction of the first digital assistant in place of the first user.

In some embodiments, the configuration operation includes: selecting a data source for use by the first digital assistant in interaction with the second user, or setting a guide phrase for displaying to the second user.

In some embodiments, the process 800 further includes: in response to the configuration operation taking effect, displaying a deactivation control in a user personal homepage of the first user or an assistant personal homepage of the first digital assistant; and in response to the deactivation control being triggered, disabling the first digital assistant from placing the first user from interacting with the second user.

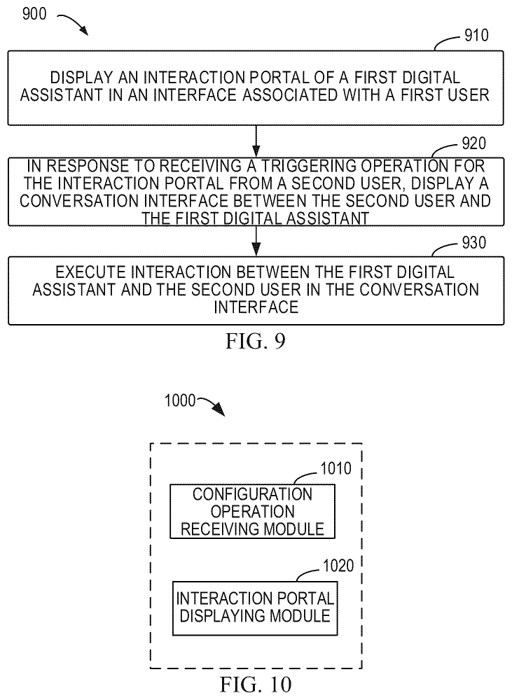

FIG. 9 illustrates a flowchart of a process 900 for conversation interaction according to some embodiments of the disclosure. The process 900 can be implemented at terminal device 110. The process 900 is described below with reference to FIG. 1.

At block 910, the terminal device 110 displays an interaction portal of a first digital assistant in an interface associated with a first user.

In block 920, the terminal device 110 displays, in response to receiving a triggering operation for the interaction portal from a second user, a conversation interface between the second user and the first digital assistant.

At block 930, the terminal device 110 executes interaction between the first digital assistant and the second user in the conversation interface.

In some embodiments, the interface associated with the first user includes at least one of: a conversation interface between the second user and the first user, or a user personal homepage of the first user.

In some embodiments, the process 900 further includes displaying, to the first user, information relating to interaction between the first digital assistant and the second user.

In some embodiments, displaying the information relating to the interaction between the first digital assistant and the second user includes at least one of: displaying, in a conversation interface between the first user and the first digital assistant, a message from the first digital assistant, the message comprising a record of the interaction, displaying, in a conversation interface between the first user and the first digital assistant, a plurality of messages generated in the interaction in an aggregate form, or displaying, in a conversation interface between the first user and the second user, the plurality of messages generated in the interaction.

### Example Apparatus and Devices

FIG. 10 shows a schematic structural block diagram of an apparatus 1000 for information interaction according to certain embodiments of the present disclosure. The apparatus 1000 may be implemented as or included in a terminal device 110. The various modules/components in the apparatus 1000 may be implemented by hardware, software, firmware, or any combination thereof.

As shown, apparatus 1000 includes a configuration operation receiving module 1010 configured to receive a configuration operation from a first user, the configuration operation being configured to configure a first digital assistant to replace the first user to interact with a second user. The apparatus 1000 further includes an interaction portal displaying module 1020 configured to display, in response to the configuration operation taking effect, an interaction portal of the first digital assistant in an interface associated with the first user, so that the second user interact with the first digital assistant.

In some embodiments, the configuration operation receiving module 1010 is further configured to: receive the configuration operation from the first user includes the configuration operation via at least one of: a conversation interface of the first user with the first digital assistant, a user personal homepage of the first user, or an assistant personal homepage of the first digital assistant.

In some embodiments, the configuration operation receiving module 1010 is further configured to: show a first message from the first digital assistant in the conversation interface, the first message being provided with a configuration control; and receive the configuration operation via the configuration control.

In some embodiments, the interaction portal displaying module 1020 is further configured to: show a second message from the first digital assistant in the conversation interface, the second message being provided with a preset shortcut instruction; and in response to the preset shortcut instruction being triggered, show the first message

In some embodiments, the interaction portal displaying module 1020 is further configured to: show, in the user personal homepage or the assistant personal homepage, a configuration portal for configuring the first digital assistant to replace the first user to interact with the second user; show, in response to the configuration portal being triggered, a configuration interface for configuring the first digital assistant to replace the first user to interact with the second user; and receive the configuration operation in the configuration interface.

In some embodiments, an example in which the first user is replaced by the first digital assistant for interaction is further presented in the configuration interface.

In some embodiments, the interaction portal displaying module 1020 is further configured to display the interaction portal of the first digital assistant in the interface associated with the first user including displaying the interaction portal in at least one of: a conversation interface between the second user and the first user, or a personal homepage of the first user.

In some embodiments, the interaction portal displaying module 1020 is further configured to display, to the first user, information relating to interaction between the first digital assistant and the second user.

In some embodiments, the interaction portal displaying module 1020 is further configured to display the information relating to the interaction between the first digital assistant and the second user including at least one of show, in a conversation interface between the first user and the first digital assistant, a message from the first digital assistant, the message comprising a record of the interaction, show, in a conversation interface between the first user and the first digital assistant, a plurality of messages generated in the interaction in an aggregate form, or show, in a conversation interface between the first user and the second user, the plurality of messages generated in the interaction.

In some embodiments, the apparatus 1000 further comprises: an effective indication displaying module, configured to in response to the configuration operation taking effect, show, in a conversation interface between the first user and the first digital assistant, at least one of the following: text describing interaction of the first digital assistant in place of the first user, or, an icon representing interaction of the first digital assistant in place of the first user.

In some embodiments, the configuration operation includes the following: selecting a data source for use by the first digital assistant in interaction with the second user, or setting a guide phrase for displaying to the second user.

In some embodiments, the apparatus 1000 further include: a deactivation module configured to display, in response to the configuration operation taking effect, a deactivation control in a user personal homepage of the first user or an assistant personal homepage of the first digital assistant; and disable, in response to the deactivation control being triggered, the first digital assistant from replacing the first user in interacting with the second user.

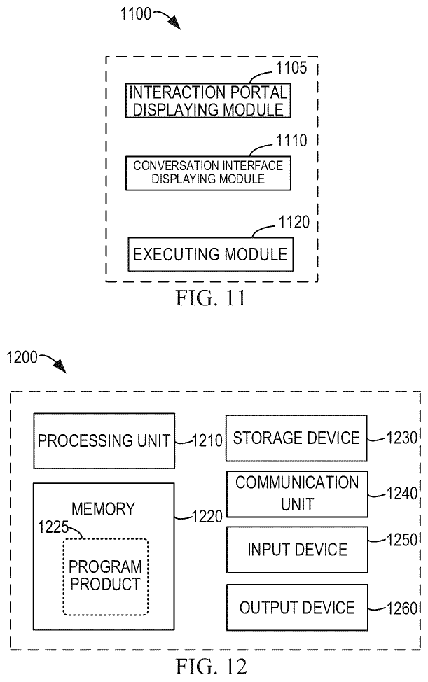

FIG. 11 shows a schematic structural block diagram of an apparatus 1100 for information interaction according to certain embodiments of the present disclosure. The apparatus 1100 may be implemented as or included in a terminal device 110. The various modules/components in the apparatus 1100 may be implemented by hardware, software, firmware or any combination thereof.

The apparatus 1100 includes an interaction portal displaying module 1105 configured to display an interaction portal of a first digital assistant in an interface associated with a first user. The apparatus 1100 further includes a conversation interface displaying module 1110 configured to display, in response to receiving a triggering operation for the interaction portal from a second user, a conversation interface between the second user and the first digital assistant. The apparatus 1100 also includes an execution module 1120 configured to execute interaction between the first digital assistant and the second user in the conversation interface.

In some embodiments, the interface associated with the first user includes at least one of a a conversation interface between the second user and the first user, or a user personal homepage of the first user.

In some embodiments, the conversation interface displaying module 1110 is further configured to display, to the first user, information relating to interaction between the first digital assistant and the second user.

In some embodiments, the conversation interface displaying module 1110 is further configured to perform at least one of: displaying, in a conversation interface between the first user and the first digital assistant, a message from the first digital assistant, the message comprising a record of the interaction, displaying, in a conversation interface between the first user and the first digital assistant, a plurality of messages generated in the interaction in an aggregate form, or displaying, in a conversation interface between the first user and the second user, the plurality of messages generated in the interaction.

FIG. 12 shows a block diagram illustrating an electronic device 1200 in which one or more embodiments of the present disclosure may be implemented. It should be appreciated that the electronic device 1200 shown in FIG. 12 is merely exemplary and should not constitute any limitation on the functionality and scope of the embodiments described herein. The electronic device 1200 shown in FIG. 12 may be configured to implement the terminal device 110 shown in FIG. 1, the apparatus 1000 shown in FIG. 10, and the apparatus 1100 shown in FIG. 11.

As shown in FIG. 12, the electronic device 1200 is in the form of a general-purpose electronic device. Components of the electronic device 1200 may include, but are not limited to, one or more processors or processing units 1210, a memory 1220, a storage device 1230, one or more communications units 1240, one or more input devices 1250, and one or more output devices 1260. The processing unit 1210 may be an actual or virtual processor and can perform various processes according to programs stored in the memory 1220. In a multiprocessor system, a plurality of processing units execute computer executable instructions in parallel, so as to improve the parallel processing capability of the electronic device 1200.

The electronic device 1200 typically includes a number of computer storage media. Such media may be any available media that are accessible by electronic device 1200, including, but not limited to, volatile and non-volatile media, removable and non-removable media. The memory 1220 may be a volatile memory (e. g., a register, cache, random access memory (RAM)), non-volatile memory (e.g., read-only memory (ROM), electrically erasable programmable read-only memory (EEPROM), flash memory), or some combination thereof. The storage device 1230 may be a removable or non-removable medium and may include a machine-readable medium such as a flash drive, a magnetic disk, or any other medium that can be used to store information and/or data and that can be accessed within the electronic device 1200.

The electronic device 1200 may further include additional removable/non-removable, volatile/nonvolatile storage media. Although not shown in FIG. 12, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 1220 may include a computer program product 1225 having one or more program modules configured to perform various methods or actions of various embodiments of the present disclosure.

The communication unit 1240 implements communication with other electronic devices through a communication medium. In addition, functions of components of the electronic device 1200 may be implemented by a single computing cluster or a plurality of computing machines, and these computing machines can communicate through a communication connection. Thus, the electronic device 1200 may operate in a networked environment using logical connections to one or more other servers, network personal computers (PCs), or another network node.

The input device 1250 may be one or more input devices such as a mouse, keyboard, trackball, etc. The output device 1260 may be one or more output devices such as a display, speaker, printer, etc. The electronic device 1200 may also communicate with one or more external devices (not shown) such as a storage device, a display device, or the like through the communication unit 1240 as required, and communicate with one or more devices that enable a user to interact with the electronic device 1200, or communicate with any device (e. g., a network card, a modem, or the like) that enables the electronic device 1200 to communicate with one or more other electronic devices. Such communication may be performed via an input/output (I/O) interface (not shown).

According to an exemplary implementation of the present disclosure, a computer readable storage medium is provided, on which a computer-executable instruction is stored, wherein the computer executable instruction is executed by a processor to implement the above-described method. According to an exemplary implementation of the present disclosure, there is also provided a computer program product, which is tangibly stored on a non-transitory computer readable medium and includes computer-executable instructions that are executed by a processor to implement the method described above.

Aspects of the present disclosure are described herein with reference to flowchart and/or block diagrams of methods, apparatus, devices and computer program products implemented in accordance with the present disclosure. It will be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/actions specified in one or more blocks of the flowchart and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may be loaded onto a computer, other programmable data processing apparatus, or other devices, causing a series of operational steps to be performed on a computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods and computer program products according to various implementations of the present disclosure. In this regard, each block in the flowchart or block diagram may represent a module, segment, or portion of instructions which includes one or more executable instructions for implementing the specified logical function(s). In some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description is exemplary, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein

What is claimed is:

1. A method for conversation interaction, comprising:
receiving a configuration operation from a first user, the configuration operation being configured to configure a first digital assistant to replace the first user to interact with a second user; and
in response to the configuration operation taking effect, displaying an interaction portal of the first digital assistant in an interface associated with the first user, so that the second user interact with the first digital assistant.

2. The method of claim 1, wherein receiving the configuration operation from the first user comprises receiving the configuration operation via at least one of:
a conversation interface between the first user and the first digital assistant,
a user personal homepage of the first user, or
an assistant personal homepage of the first digital assistant.

3. The method of claim 2, wherein receiving the configuration operation via the conversation interface comprises:
displaying a first message from the first digital assistant in the conversation interface, the first message being provided with a configuration control; and
receiving the configuration operation via the configuration control.

4. The method of claim 3, wherein displaying the first message from the first digital assistant comprises:
displaying a second message from the first digital assistant in the conversation interface, the second message being provided with a preset shortcut instruction; and
in response to the preset shortcut instruction being triggered, displaying the first message.

5. The method of claim 2, wherein receiving the configuration operation via the user personal homepage or the assistant personal homepage comprises:
displaying, in the user personal homepage or the assistant personal homepage, a configuration portal for configuring the first digital assistant to replace the first user to interact with the second user;
displaying, in response to the configuration portal being triggered, a configuration interface for configuring the first digital assistant to replace the first user to interact with the second user; and
receiving the configuration operation in the configuration interface.

6. The method of claim 5, wherein an example in which the first user is replaced by the first digital assistant for interaction is further presented in the configuration interface.

7. The method of claim 1, wherein displaying the interaction portal of the first digital assistant in the interface associated with the first user comprises displaying the interaction portal in at least one of:
a conversation interface between the second user and the first user, or
a personal homepage of the first user.

8. The method of claim 1, further comprising:
displaying, to the first user, information relating to interaction between the first digital assistant and the second user.

9. The method of claim 8, wherein displaying the information relating to the interaction between the first digital assistant and the second user comprises at least one of:
displaying, in a conversation interface between the first user and the first digital assistant, a message from the first digital assistant, the message comprising a record of the interaction,
displaying, in a conversation interface between the first user and the first digital assistant, a plurality of messages generated in the interaction in an aggregate form, or
displaying, in a conversation interface between the first user and the second user, the plurality of messages generated in the interaction.

10. The method of claim 1, further comprising:
in response to the configuration operation taking effect, displaying, in a conversation interface between the first user and the first digital assistant, at least one of the following:
text describing interaction of the first digital assistant in place of the first user, or
an icon representing the interaction of the first digital assistant in place of the first user.

11. The method according to claim 1, wherein the configuration operation comprises:
selecting a data source for use by the first digital assistant in interaction with the second user, or
setting a guide phrase for displaying to the second user.

12. The method of claim 1, further comprising:
in response to the configuration operation taking effect, displaying a deactivation control in a user personal homepage of the first user or an assistant personal homepage of the first digital assistant; and
in response to the deactivation control being triggered, disabling the first digital assistant from replacing the first user in interacting with the second user.

13. A method for conversation interaction, comprising:
displaying an interaction portal of a first digital assistant in an interface associated with a first user;
in response to receiving a triggering operation for the interaction portal from a second user, displaying a conversation interface between the second user and the first digital assistant; and
executing interaction between the first digital assistant and the second user in the conversation interface.

14. The method of claim 13, wherein the interface associated with the first user comprises at least one of:
a conversation interface between the second user and the first user, or
a user personal homepage of the first user.

15. The method of claim 13, further comprising:
displaying, to the first user, information relating to interaction between the first digital assistant and the second user.

16. The method of claim 15, wherein displaying the information relating to the interaction between the first digital assistant and the second user comprises at least one of:
displaying, in a conversation interface between the first user and the first digital assistant, a message from the first digital assistant, the message comprising a record of the interaction,
displaying, in a conversation interface between the first user and the first digital assistant, a plurality of messages generated in the interaction in an aggregate form, or
displaying, in a conversation interface between the first user and the second user, the plurality of messages generated in the interaction.

17. An electronic device, comprising:
at least one processing unit; and
at least one memory coupled to the at least one processing unit and storing instructions for execution by the at least one processing unit, the instructions, when executed by the at least one processing unit, cause the electronic device to perform acts comprising:
receiving a configuration operation from a first user, the configuration operation being configured to configure a first digital assistant to replace the first user to interact with a second user; and
in response to the configuration operation taking effect, displaying an interaction portal of the first digital assistant in an interface associated with the first user, so that the second user interact with the first digital assistant.

18. The device of claim 17, wherein receiving the configuration operation from the first user comprises receiving the configuration operation via at least one of:
a conversation interface between the first user and the first digital assistant,
a user personal homepage of the first user, or
an assistant personal homepage of the first digital assistant.

19. The device of claim 18, wherein receiving the configuration operation via the conversation interface comprises:
displaying a first message from the first digital assistant in the conversation interface, the first message being provided with a configuration control; and
receiving the configuration operation via the configuration control.

20. The device of claim 17, wherein displaying the interaction portal of the first digital assistant in the interface associated with the first user comprises displaying the interaction portal in at least one of:
a conversation interface between the second user and the first user, or
a personal homepage of the first user.
